(19) United States
(12) Patent Application Publication
(10) Pub. No.: US 2020/0063671 A1
(43) Pub. Date: Feb. 27, 2020

(54) ENGINE SYSTEM

(71) Applicant: AISAN KOGYO KABUSHIKI KAISHA, Obu-shi (JP)

(72) Inventor: Daisaku ASANUMA, Gamagori-shi (JP)

(73) Assignee: AISAN KOGYO KABUSHIKI KAISHA, Obu-shi (JP)

(21) Appl. No.: 16/513,964

(22) Filed: Jul. 17, 2019

(30) Foreign Application Priority Data
Aug. 23, 2018 (JP) 2018-155938

(51) Int. Cl. F02D 41/00; F02M 25/08; B60K 6/46; B60K 6/24

(52) U.S. Cl. CPC F02D 41/004; F02D 41/0042; F02M 25/0836; F02M 25/089; B60Y 2400/43; B60K 6/24; F02D 2200/04; B60Y 2200/92; B60K 6/46

(57) ABSTRACT

An engine system for a hybrid vehicle includes an intake passage, an injector, a vaporized-fuel treating apparatus, a vapor concentration sensor, an airflow meter, and an ECU. The vaporized-fuel treating apparatus is configured to collect vapor generated in a fuel tank into a canister, and purge the vaporized fuel into the intake passage through a purge passage provided with a purge valve and a purge pump. The ECU causes an injector to regulate an amount of fuel to be supplied to an engine during steady operation, and opens the purge valve. When an intake amount increases above an upper-limit intake amount, the ECU limits an upper limit of the detected intake amount to the upper-limit intake amount, calculates a request pump rotation number based on the upper-limit intake amount and a vapor concentration, and controls the purge pump based on the calculated request pump rotation number.

### CROSS-REFERENCE TO RELATED APPLICATIONS

This application is based upon and claims the benefit of priority from the prior Japanese Patent Application No. 2018-155938 filed on Aug. 23, 2018, the entire contents of which are incorporated herein by reference.

### BACKGROUND

### Technical Field

The present disclosure relates to an engine system to be mounted in a hybrid vehicle, the engine system including an engine, a fuel supply unit for supplying fuel to the engine, a fuel tank for storing fuel to be supplied to the engine, and a vaporized-fuel treating apparatus for treating vaporized fuel generated in the fuel tank.

### Related Art

As a technique of the above type, conventionally, there is known a vaporized-fuel treating apparatus described for example in Japanese unexamined patent application publication No. 2017-67008 (JP2017-67008A). This apparatus includes a canister for collecting or trapping vaporized fuel (vapor) generated in a fuel tank, a purge passage for directing the vapor collected in the canister to an intake passage of an engine, a purge valve for opening and closing the purge passage, a purge pump provided in the purge passage and configured to deliver the vapor under pressure from the canister to the intake passage, and an electronic control unit (ECU) for controlling the purge valve and the purge pump. The ECU controls the purge valve and the purge pump according to an operating state of the engine to thereby regulate a purge flow rate of vapor allowed to flow in the intake passage. In some cases, this apparatus is mounted in a series-hybrid vehicle. The series-hybrid vehicle is configured to use an engine only for generating of electric power and use a motor only for driving and regenerative braking of wheels, and include a rechargeable or storage battery for collecting electric power. This series-hybrid vehicle can correspond to an electric vehicle that mounts an engine as a drive source for power generation. In the vaporized-fuel treating apparatus mounted in the series-hybrid vehicle, even though not explicitly described in JP2017-67008A, the engine is operated for steady operation based on a state of charge of the rechargeable battery, a fuel consumption in the engine, and other conditions. During steady operation of the engine, the request number of rotations of the purge pump is constant, so that the purge pump is controlled at a constant pump rotation number.

### SUMMARY

### Technical Problem

Meanwhile, in the foregoing hybrid vehicle, the engine may shift to a transient operation (acceleration operation or deceleration operation) according to a request for power generation during engine steady operation. When the engine shifts to the transient operation and an intake amount of the engine varies, i.e., increases and decreases, the request pump rotation number of the purge pump varies in sync therewith. The purge pump is thus controlled according to such variations. However, in many cases, the actual pump rotation number of the purge pump could not exactly follow the variations of the request pump rotation number. In the case where the request pump rotation number changes from increase to decrease, especially, a decrease in pump rotation number by control is delayed, which may cause an excessive increase in purge flow rate with respect to changes in intake amount. In this case, the vapor supplied to the engine may become excessive temporarily, leading to fluctuation or disturbance of the air-fuel ratio in the engine.

The present disclosure has been made to address the above problems and has a purpose to provide an engine system capable of reducing variations of the request pump rotation number to be calculated according to an intake amount and preventing excessive supply of vaporized fuel to the engine in a series-hybrid vehicle even when the intake amount varies during steady operation of the engine.

### Means of Solving the Problem

To achieve the above-mentioned purpose, one aspect of the present disclosure provides an engine system to be mounted in a series-hybrid vehicle, the engine system comprising: an engine; an intake passage configured to introduce intake air into the engine; a fuel supply unit configured to supply fuel to the engine; a fuel tank configured to store the fuel to be supplied to the engine; a vaporized-fuel treating apparatus including: a canister configured to collect vaporized fuel generated in the fuel tank; a purge passage; a purge valve provided in the purge passage; and a turbine purge pump provided in the purge passage, the vaporized-fuel treating apparatus being configured to treat the vaporized fuel temporarily collected in the canister by purging the vaporized fuel into the intake passage through the purge passage; a vaporized-fuel concentration detecting unit configured to detect a concentration of the vaporized fuel to be purged into the intake passage; an intake amount detecting unit configured to detect an intake amount of air flowing through the intake passage; and a controller configured to control the fuel supply unit, the purge valve, and the purge pump, the controller being configured to: control the fuel supply unit to regulate an amount of the fuel to be supplied to the engine during operation of the engine; open the purge valve to regulate an amount of the vaporized fuel to be purged into the intake passage; calculate a request pump rotation number based on the detected intake amount and the detected concentration of the vaporized fuel; and control the purge pump based on the calculated request pump rotation number, wherein when the intake amount increases above a predetermined upper-limit intake amount during steady operation of the engine, the controller is configured to limit an upper limit of the detected intake amount to the predetermined upper-limit intake amount, and calculate the request pump rotation number based on the upper-limit intake amount and the concentration of the vaporized fuel.

According to this disclosure, even when an intake amount varies during steady operation of an engine in a series-hybrid vehicle, it is possible to reduce variations in the request pump rotation number to be calculated according to the intake amount, prevent excessive supply of vaporized fuel to the engine, thereby restricting disturbance of an air-fuel ratio in the engine.

### BRIEF DESCRIPTION OF THE DRAWING

FIG. 1 is a schematic diagram showing an engine system including a vaporized-fuel treating apparatus mounted in a hybrid vehicle in a first embodiment;

FIG. 2 is a flowchart showing details of first purge control in the first embodiment;

FIG. 3 is an upper-limit intake amount map to be referred to in order to obtain an upper-limit intake amount according to a mode in the first embodiment;

FIG. 4 is a request pump rotation number map to be referred to in order to obtain a request pump rotation number according to a request purge flow rate in the first embodiment;

FIGS. 5A-5I are time charts showing one example of behaviors of various parameters in the first purge control in the first embodiment;

FIG. 6 is a flowchart showing details of purge cut control in a second embodiment;

FIG. 7 is a purge flow rate map to be referred to in order to calculate a purge flow rate according to the number of pump rotations in the second embodiment;

FIGS. 8A-8F are time charts showing one example of behaviors of various parameters in the purge cut control in the second embodiment;

FIG. 9 is a flowchart showing details of second purge control in a third embodiment;

FIG. 10 is a flowchart showing details of purge pump control in a fourth embodiment;

FIG. 11 is a first request pump rotation number map to be referred to in order to obtain a request pump rotation number according to a vapor concentration in the fourth embodiment;

FIG. 12 is a second request pump rotation number map to be referred to in order to obtain a request pump rotation number according to a vapor concentration in the fourth embodiment;

FIG. 13 is a first pump flow rate map to be referred to in order to obtain a pump flow rate according to an actual pump rotation number in the fourth embodiment;

FIG. 14 is a second pump flow rate map to be referred to in order to a pump flow rate according to an actual pump rotation number in the fourth embodiment; and

FIGS. 15A-15H are time charts showing one example of behaviors of various parameters in purge pump control in the fourth embodiment.

### DETAILED DESCRIPTION OF THE EXEMPLARY EMBODIMENTS

### First Embodiment

A detailed description of a first embodiment of an engine system of this disclosure will now be given referring to the accompanying drawings.

### (Outline of Engine System)

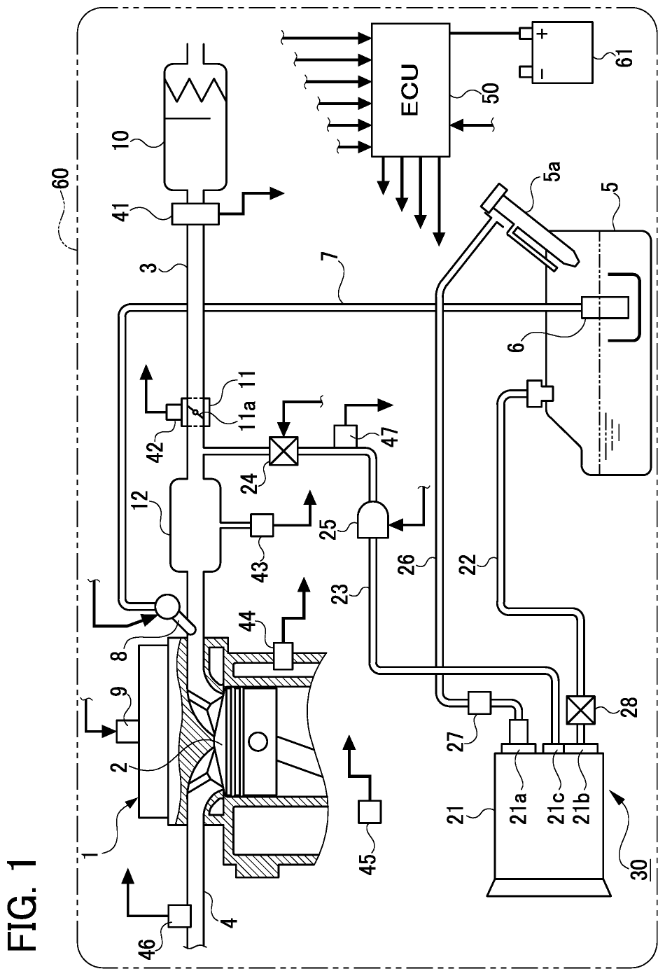

FIG. 1 is a schematic diagram showing an engine system including a vaporized-fuel treating apparatus 30 mounted in a hybrid vehicle 60. This hybrid vehicle 60 in the present embodiment is a series-hybrid vehicle. This series-hybrid vehicle 60 uses an engine 1 only for generation of electric power and a motor (not shown) only for driving and regenerative braking of wheels, and includes a rechargeable battery (a storage battery) 61 to collect electric power. The engine 1 is provided with an intake passage 3 to draw air and others into a combustion chamber 2, and an exhaust passage 4 to discharge exhaust gas from the combustion chamber 2. The combustion chamber 2 is supplied with fuel stored in a fuel tank 5. Specifically, the fuel in the fuel tank 5 is pumped out by a fuel pump 6 built in the fuel tank 5 into a fuel passage 7, and then the fuel is delivered under pressure to an injector 8 provided in an intake port of the engine 1. The fuel delivered under pressure is injected from the injector 8, and introduced together with the air flowing through the intake passage 3 to form a combustible air-fuel mixture in the combustion chamber 2 in which this mixture is combusted. The engine 1 is provided with an ignition device 9 to ignite the combustible air-fuel mixture. The injector 8 is one example of a fuel supply unit in the present disclosure.

In the intake passage 3, in the order from its inlet side, an air cleaner 10, a throttle device 11, and a surge tank 12 are arranged. The throttle device 11 includes a throttle valve 11a and is configured to open and close the throttle valve 11a to regulate a flow rate of intake air flowing through the intake passage 3. Opening and closing of the throttle valve 11a are interlocked with an operation of an accelerator pedal (not shown) by a driver. The surge tank 12 is configured to smoothen pulsation of intake air in the intake passage 3.

### (Structure of Vaporized-Fuel Treating Apparatus)

In FIG. 1, the vaporized-fuel treating apparatus 30 in the present embodiment is configured to treat vaporized fuel (vapor) generated in the fuel tank 5 without allowing the vaporized fuel to release into the atmosphere. This apparatus 30 includes a canister 21 to collect vapor generated in the fuel tank 5, a vapor passage 22 to introduce the vapor from the fuel tank 5 into the canister 21, a purge passage 23 to purge the vapor collected in the canister 21 into the intake passage 3, a purge valve 24 to open and close the purge passage 23, and a purge pump 25 provided between the canister 21 and the purge valve 24 to deliver the vapor under pressure from the canister 21 to the purge passage 23.

The canister 21 internally contains adsorbing material, such as activated carbon. The canister 21 includes an atmosphere port 21a for introducing atmospheric air, an inlet port for introducing vapor, and an outlet port 21c for discharging vapor. The internal space of the canister 21 communicates with the atmosphere. Specifically, an atmosphere passage 26 extending from the atmosphere port 21a has a distal end communicating with an entrance of an oil filler pipe 5a of the fuel tank 5. In this atmosphere passage 26, a filter 27 is provided to collect powder dust or the like in air. The vapor passage 22 extending from the inlet port 21b of the canister 21 has a distal end communicating with the inside of the fuel tank 5. The purge passage 23 provided between the canister 21 and the intake passage 3 has a distal end communicating with the intake passage 3 located between the throttle device 11 and the surge tank 12.

In the present embodiment, the purge valve 24 is constituted of an electrically-operated on-off valve (a shutoff valve) and configured to open and close the purge passage 23. The purge pump 25 is configured to be able to change an ejection amount of vapor to deliver the vapor under pressure from the canister 21 to the purge passage 23. In the present embodiment, a turbine pump is employed as the purge pump 25. The turbine pump is configured to rotate its impeller in a normal direction and a reverse direction and to regulate a purge flow rate during reverse rotation lower than a purge flow rate during normal rotation.

The vaporized-fuel treating apparatus 30 configured as above introduces the vapor generated in the fuel tank 5 into the canister 21 through the vapor passage 22 and collects the vapor temporarily in the canister 21. During operation of the engine 1, the throttle device 11 (i.e., the throttle valve 11a) is opened, the purge valve 24 is opened, and the purge pump 25 is operated. Thus, the vapor collected in the canister 21 is purged from the canister 21 into the intake passage 3 through the purge passage 23. The purge flow rate of the vapor can be regulated by control of the rotation of the purge pump 25. In the present embodiment in which the purge pump 25 is a turbine pump, the purge pump 25, i.e., its impeller, can be rotated normally and reversely, enabling the purge flow rate to be regulated by control of the number of rotations NP of the purge pump 25 (namely, “pump rotation number”). By rotating the purge pump 25 reversely from a normal rotating state, the purge flow rate can be regulated at a low flow rate.

In the present embodiment, in the vapor passage 22, a cut-off valve 28 to control a gas flow between the fuel tank 5 and the canister 21. This cut-off valve 28 is configured to open when the inner pressure of the fuel tank 5 is a positive pressure that is equal to or higher than a predetermined value and to close under negative pressure generated when the vapor collected in the canister 21 is purged into the intake passage 3.

### (Electrical Configuration of Engine System)

In the present embodiment, various sensors 41 to 46 and others are provided to detect an operating state of the engine 1. Specifically, the airflow meter 41 placed near the air cleaner 10 is configured to detect an amount of air to be drawn into the intake passage 3 as an intake amount and output an electric signal representing a detected value. The airflow meter 41 corresponds to one example of an intake amount detecting unit in the present disclosure. The throttle sensor 42 provided to the throttle device 11 is configured to detect an opening degree of the throttle valve 11a as a throttle opening degree and output an electric signal representing a detected value. The intake pressure sensor 43 provided to the surge tank 12 is configured to detect the inner pressure of the surge tank 12 as intake pressure and output an electric signal representing a detected value. The water temperature sensor 44 provided to the engine 1 is configured to detect the temperature of cooling water flowing through the inside of the engine 1 as a cooling-water temperature and output an electric signal representing a detected value. The rotation number sensor 45 provided to the engine 1 is configured to detect a rotation angle speed of a crank shaft (not shown) of the engine 1 as an engine rotation number NE and output an electric signal representing a detected value. The oxygen sensor 46 provided in the exhaust passage 4 is configured to detect the concentration of oxygen in the exhaust gas and output an electric signal representing a detected value. In the vaporized-fuel treating apparatus 30 in the present embodiment, a vapor concentration sensor 47 dedicated to detect the concentration of vapor (i.e., vapor concentration) VPs purged from the purge passage 23 into the intake passage 3 is provided in the purge passage 23. The vapor concentration sensor 47 corresponds to one example of a vaporized-fuel concentration detecting unit in the present disclosure.

In the present embodiment, an electronic control unit (ECU) 50 responsible for various controls receives various signals from the various sensors 41 to 47 and others. The ECU 50 is configured to control the injector 8, the ignition device 9, the purge valve 24, and the purge pump 25 based on those signals input to the ECU 50 to perform fuel injection control, ignition timing control, and purge control.

Furthermore, the hybrid vehicle 60 is provided with a motor (not shown) for driving, and a rechargeable battery 61 to supply electric power to the motor. The ECU 50 is configured to monitor the state of this rechargeable battery 61, that is, the state of voltage and the state of current.

Herein, the fuel injection control indicates controlling the injector 8 according to the operating state of the engine 1 to thereby control the fuel injection amount and the fuel injection timing. The ignition timing control indicates controlling the ignition device 9 according to the operating state of the engine 1 to thereby control the ignition timing of combustible air-fuel mixture. The purge control indicates controlling the purge valve 24 and the purge pump 25 according to the operating state of the engine 1 to thereby control a purge flow rate of vapor to be purged from the canister 21 to the intake passage 3 through the purge passage 23.

In the present embodiment, the ECU 50 is provided with well-known components including a central processing unit (CPU), a read only memory (ROM), a random-access memory (RAM), a backup RAM, and others. The ROM stores in advance predetermined control programs related to the foregoing various controls. The ECU (CPU) 50 is configured to perform the foregoing various controls according to the control programs. The ECU 50 corresponds to one example of a controller in the present embodiment.

In the present embodiment, the ECU 50 is configured to open the purge valve 24 and control the purge pump 25 at the constant number of pump rotations in order to purge a constant flow rate of vapor into the intake passage 3 during steady operation of the engine 1. The present embodiment adopts well-known contents for the fuel injection control and the ignition timing control and thus shows details of only the purge control as below.

Meanwhile, in the hybrid vehicle 60, the engine 1 may shift to a transient operation (an accelerating operation or decelerating operation) in response to a request for power generation during steady operation of the engine 1. At that time, the intake amount of the engine 1 increases and decreases, the calculated request pump rotation number increases and decreases, and the purge pump 25 is controlled according to the increased or decreased request pump rotation number. This control of the purge pump 25 exhibits poor following performance, which may cause a delay in regulation of a purge flow rate of vapor, resulting in deterioration in the air-fuel ratio in the engine 1. If the intake amount of the engine 1 is small, the purge flow rate could not sometimes be regulated even when the purge pump 25 is controlled. In the present embodiment, therefore, the ECU 50 is configured to perform first purge control which will be described below.

### (First Purge Control)

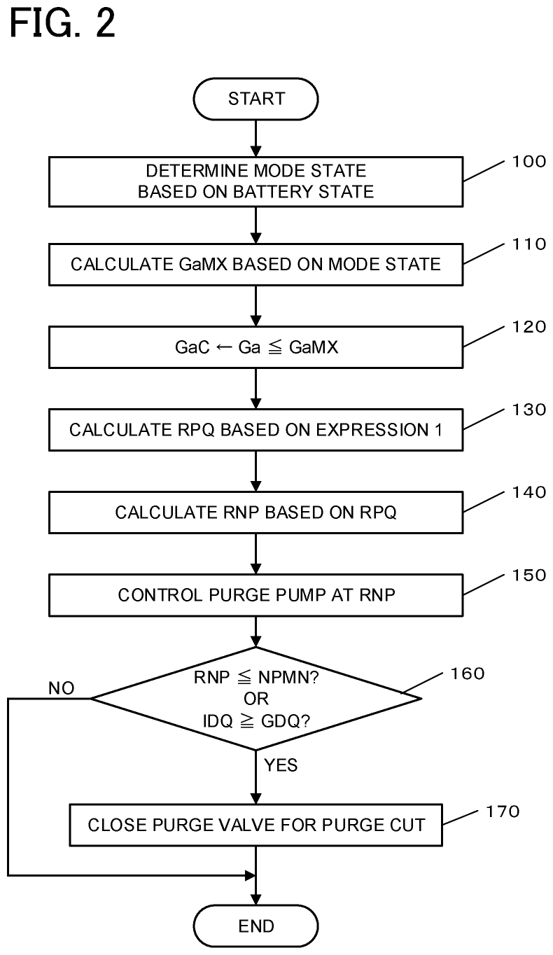

The first purge control will be described below. FIG. 2 is a flowchart showing details of this purge control. The ECU 50 is configured to periodically perform this routine at predetermined time intervals.

When the processing enters this routine, in step 100, the ECU 50 detects the state of the rechargeable battery 61 (the battery state, e.g., the state of voltage and the state of current) and determines a mode state (e.g., mode 1, mode 2, mode 3, or mode 4) related to the purge control based on the detected battery state.

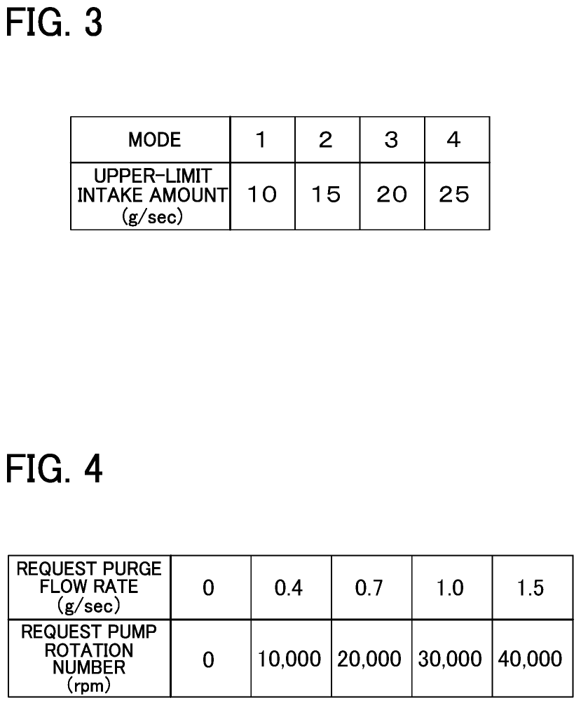

In step 110, the ECU 50 obtains an upper-limit intake amount GaMX based on the determined mode state. For instance, the ECU 50 can obtain this upper-limit intake amount GaMX from among set values corresponding to the modes 1 to 4 by referring to an upper-limit intake amount map set in advance as shown in FIG. 3. In this map, the upper-limit intake amount GaMX is set to 10, 15, 20, and 25 (g/sec) respectively for the modes 1, 2, 3, and 4.

In steps 100 and 110, specifically, based on the state of the rechargeable battery 61, the ECU 50 determines the condition for steady operation according to the previously set modes 1 to 4, that is, the upper-limit intake amount GaMX.

In step 120, successively, the ECU 50 controls the throttle device 11 so that the intake amount Ga detected by the airflow meter 41 is equal to or lower than the upper-limit intake amount GaMX. This controlled intake amount is set as a control intake amount GaC.

In step 130, the ECU 50 calculates a request, or required, purge flow rate RPQ based on the following expression (1):

RPQ=(IDQ*GaC*PAF)/(SAF*100) (Exp. 1)

wherein “IDQ” represents a decrement of the amount of fuel to be injected from the injector 8 (namely, a decrement by injector, also referred to as “injector decrement”). In the present embodiment, in the fuel injection control which is performed in parallel with the purge control, if an actual intake amount Ga decreases below the upper-limit intake amount GaMX, the injector 8 is controlled to reduce the amount of fuel to be supplied to the engine 1 by the injector decrement IDQ. In the expression 1, “PAF” indicates a purge air-fuel ratio of the vapor. The ECU 50 calculates the purge air-fuel ratio PAF based on the vapor concentration VPs detected by the vapor concentration sensor 47. As an alternative, the air-fuel ratio PAF may be obtained from a feedback deviation by the oxygen sensor 46 during purge stop. In the expression 1, “SAF” denotes a stoichiometric air-fuel ratio to which 14.5 is assigned in the present embodiment.

Herein, the injector decrement IDQ is set as a value (e.g., 20%) having an allowance relative to a guard decrement GDQ (e.g., 40%) as a limit value, so that it can be corrected even when a relationship; “Request pump rotation number RNP<Actual pump rotation number NP” is met.

In step 140, the ECU 50 calculates a request pump rotation number RNP based on the request purge flow rate RPQ. For instance, the ECU 50 can obtain the request pump rotation number RNP according to the request purge flow rate RPQ by referring to a request pump rotation number map set in advance as shown in FIG. 4. In this map, as the request purge flow rate RPQ is higher among 0, 0.4, 0.7, 1.0, and 1.5 (g/sec), the request pump rotation number RNP is respectively higher among 0, 10000, 20000, 30000, and 40000 (rpm).

In steps 120 to 140, specifically, when the actual intake amount Ga decreases below the upper-limit intake amount GaMX, the ECU 50 determines the request pump rotation number RNP based on the intake amount Ga and the purge air-fuel ratio.

In step 150, the ECU 50 controls the purge pump 25 to the request pump rotation number RNP.

In step 160, the ECU 50 determines either (i) whether or not the request pump rotation number RNP is equal to or lower than a lower-limit pump rotation number NPMN or (ii) whether or not the injector decrement IDQ is equal to or larger than the guard decrement GDQ. If this determination result is affirmative (Step 160: YES), the ECU 50 advances the processing to step 170. In this determination result is negative (Step 160: NO), in contrast, the ECU 50 stops the subsequent processing once.

In step 170, the ECU 50 closes the purge valve 24 to cut off purging of vapor, i.e., to perform “purge cut”, and further temporarily stops the subsequent processing.

Herein, when the request pump rotation number obtained in step 140 falls below the lower-limit pump rotation number (e.g., 8000 rpm), the purge cut is performed. Further, when the injector decrement IDQ becomes equal to the guard decrement GDQ, the purge cut is performed.

According to the first purge control described above, during operation of the engine 1, the ECU 50 is configured to control the injector 8 to adjust an amount of fuel to be supplied to the engine 1, open the purge valve 24 to regulate an amount of vapor to be purged into the intake passage 3 and calculate the request pump rotation number RNP based on the detected intake amount Ga and the detected vapor concentration VPs, and control the purge pump 25 based on the calculated request pump rotation number RNP. In addition, during steady operation of the engine 1, when the actual intake amount Ga becomes larger than the predetermined upper-limit intake amount GaMX, the ECU 50 is configured to limit the upper-limit of the detected intake amount Ga to the upper-limit intake amount GaMX and calculate the request pump rotation number RNP based on the upper-limit intake amount GaMX and the vapor concentration VPs.

According to the first purge control described above, when the actual intake amount Ga becomes smaller than the upper-limit intake amount GaMX and the request pump rotation number RNP becomes equal to or lower than the lower-limit pump rotation number NPMN, or alternatively, when the injector decrement IDQ becomes equal to or larger than the guard decrement GDQ, the ECU 50 is configured to close the purge valve 24 to cut off purging of vapor, i.e., perform the purge cut.

According to the foregoing first purge control, when the actual intake amount Ga decreases below the upper-limit intake amount GaMX, the ECU 50 controls the injector 8 to decrease the amount of fuel to be supplied to the engine 1 in a range down to a predetermined limit value (i.e., the guard decrement GDQ). If the amount of decrease, or a decrement, of the fuel to be decreased only by the injector 8 is not sufficient for the decreased intake amount, the ECU 50 also controls the purge valve 24 to close to perform the purge cut of vapor.

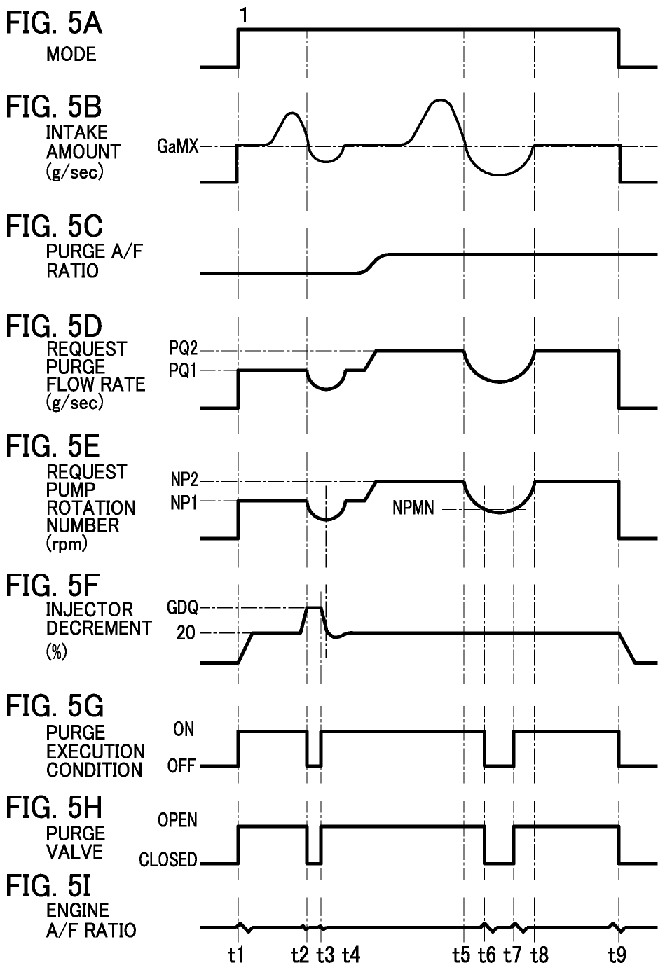

Herein, one example of behaviors of various parameters in the first purge control is shown in time charts in FIGS. 5A-5I. FIG. 5A shows changes in mode, FIG. 5B indicates variations in intake amount Ga, FIG. 5C exhibits variations in purge air-fuel ratio PAF, FIG. 5D shows variations in request purge flow rate RPQ, FIG. 5E indicates variations in request pump rotation number RNP, FIG. 5F represents variations in injector decrement IDQ, FIG. 5G shows changes in purge execution condition, FIG. 5H shows an open/closed state of the purge valve 24, and FIG. 5I shows variations in engine air-fuel ratio.

In FIGS. 5A-5I, during steady operation of the engine 1, at time t1, when the mode in FIG. 5A is determined at 1 and the purge air-fuel ratio in FIG. 5C is a certain value, the intake amount Ga in FIG. 5B reaches the upper-limit intake amount GaMX and the request purge flow rate RPQ in FIG. 5D becomes a first predetermined value PQ1, and the request pump rotation number RNP in FIG. 5E becomes a first predetermined value NP1. Simultaneously, the purge execution condition in FIG. 5G is met (ON), and the purge valve 24 in FIG. 5H is turned to OPEN. At that time, the engine air-fuel ratio in FIG. 5I varies for a moment. Further, the injector decrement IDQ in FIG. 5F starts to increase in sync with execution of purge. Herein, between time t1 to time t2, the actual intake amount Ga in FIG. 5B increases above the upper-limit intake amount GaMX. In this case, however, the upper-limit of the detected intake amount Ga is limited to the upper-limit intake amount GaMX, the request pump rotation number RNP is calculated based on the upper-limit intake amount GaMX, the vapor concentration VPs, and others, and the request pump rotation number RNP becomes stable at the first predetermined value NP1.

Thereafter, between time t2 to time t4, the actual intake amount Ga in FIG. 5B decreases once below the upper-limit intake amount GaMX and accordingly the request purge flow rate RPQ in FIG. 5D decreases once, and correspondingly the request pump rotation number RNP in FIG. 5E lowers once. At that time, between time t2 to time t3, when the injector decrement IDQ in FIG. 5F reaches the guard decrement GDQ, the purge execution condition in FIG. 5G is not met (OFF) during that period, and the purge valve 24 in FIG. 5H is turned to CLOSED (purge cut).

At time t4 and subsequent, the purge air-fuel ratio in FIG. 5C increases once. However, the intake amount Ga in FIG. 5B has reached the upper-limit intake amount GaMX, so that the request purge flow rate RPQ in FIG. 5D slightly increases to and becomes stable at a second predetermined value PQ2. Accordingly, the request pump rotation number RNP in FIG. 5E slightly increases to and becomes stable at a second predetermined value NP2.

Thereafter, between time t5 to time t8, when the intake amount Ga in FIG. 5B decreases once, the request purge flow rate RPQ in FIG. 5D accordingly decreases once, and the request pump rotation number RNP in FIG. 5E correspondingly decreases once. At that time, between time t6 to time t7, when the request pump rotation number RNP in FIG. 5E decreases below the lower-limit pump rotation number NPMN, the purge execution condition is not met (OFF), and the purge valve 24 in FIG. 5H is turned to CLOSED (purge cut). By regulating the amount of fuel to be injected from the injector 8 and the purge flow rate PQ of vapor to be supplied through the purge passage 23 in the above manner, the engine air-fuel ratio in FIG. 5I is prevented from fluctuating, or being disturbed.

According to the engine system in the present embodiment described above, during operation of the engine 1, the injector 8 is controlled to regulate the amount of fuel to be supplied to the engine 1, the purge valve 24 is opened and the purge pump 25 is controlled to regulate the amount of vapor to be purged into the intake passage 3. Specifically, the request pump rotation number RNP is calculated based on the detected intake amount Ga and the detected vapor concentration VPs, and the purge pump 25 is controlled based on the calculated request pump rotation number RNP. Herein, during steady operation of the engine 1, when the actual intake amount Ga increases above the predetermined upper-limit intake amount GaMX in response to for example a power generation request, the upper-limit of the detected intake amount Ga is limited to the upper-limit intake amount GaMX. Then, the request pump rotation number RNP is calculated based on the upper-limit intake amount GaMX and the detected vapor concentration VPs, and the purge pump 25 is controlled based on the calculated request pump rotation number RNP. Consequently, even when the actual intake amount Ga increases above the predetermined upper-limit intake amount GaMX, the upper-limit of the detected intake amount Ga is limited to the upper-limit intake amount GaMX, so that variations of the calculated request pump rotation number RNP are reduced. Particularly, variations of the request pump rotation number RNP are reduced at the time when the request pump rotation number RNP turns from increase to decrease. In the series-hybrid vehicle 60, therefore, even when the intake amount Ga varies according to a power generation request or the like during steady operation of the engine 1, the engine system in the present embodiment can reduce variations of the request pump rotation number RNP calculated according to the intake amount Ga, suppress excessive supply of vapor to the engine 1, and thus restricting disturbance of an air-fuel ratio in the engine 1.

In the present embodiment, furthermore, when the actual intake amount Ga becomes smaller than the upper-limit intake amount GaMX and hence the request pump rotation number RNP becomes equal to or lower than the lower-limit pump rotation number NPMN, or alternatively, when the actual intake amount Ga becomes smaller than the upper-limit intake amount GaMX and the injector decrement IDQ becomes equal to or larger than the guard decrement GDQ, the purge valve 24 is closed to perform the purge cut. This purge cut can therefore quickly suppress excessive supply of vapor to the engine 1 and thus restricting air-fuel ratio disturbance in the engine 1.

In the present embodiment, moreover, when the actual intake amount Ga decreases below the upper-limit intake amount GaMX, the injector 8 is controlled to decrease the amount of fuel to be supplied to the engine 1 in a range down to the predetermined guard decrement GDQ. If the amount of decrease of the fuel to be decreased only by the injector 8 is not sufficient for the decreased intake amount, the purge valve 24 is closed to carry out the purge cut of vapor, thereby allowing quick decrease of the vapor to be supplied to the engine 1. Accordingly, when the intake amount Ga becomes smaller than the upper-limit intake amount GaMX, if the amount of decrease of the fuel to be decreased through the injector 8 is insufficient, the purge valve 24 can quickly suppress excessive supply of vapor to the engine 1 and thus restricting air-fuel ratio disturbance in the engine 1.

### Second Embodiment

Next, a second embodiment embodying an engine system will be described in detail below with reference to the accompanying drawings.

In this embodiment, similar or identical parts to those in the first embodiment are given the same reference signs as those in the first embodiment and their details are not elaborated upon here. The following description is made with a focus on differences from the first embodiment. The present embodiment differs from the first embodiment in the contents of the purge control.

In the vaporized-fuel treating apparatus 30 in the present embodiment, if the purge pump 25 (the pump rotation number NP) is controlled based on the request pump rotation number RNP calculated according to the intake amount Ga of the engine 1, the pump rotation number NP shows poor following performance when the intake amount Ga decreases, and the injector decrement IDQ often becomes the guard decrement GDQ corresponding to a limit value. This may deteriorate controllability of the engine air-fuel ratio due to supply of vapor. In the present embodiment, therefore, the first purge control shown in FIG. 2 is configured to perform the following purge cut control instead of the processing in step 170.

### (Purge Cut Control)

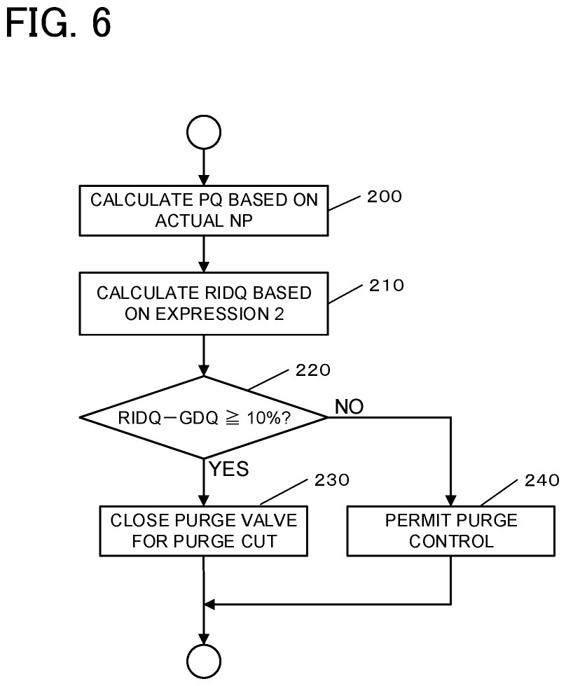

The purge cut control will be described below. FIG. 6 is a flowchart showing the contents of the purge cut control to be performed instead of step 170 in FIG. 2.

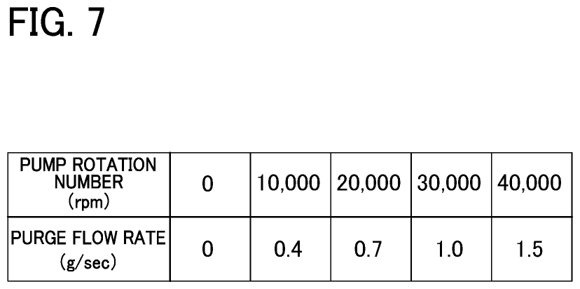

When the processing shifts from step 160 in FIG. 2 to step 200 in FIG. 6, the ECU 50 calculates a purge flow rate PQ based on an actual pump rotation number NP in step 200. The ECU 50 can calculate this purge flow rate PQ according to the pump rotation number NP by referring to a purge flow rate map shown in FIG. 7. In this map, as the pump rotation number NP is higher among 0, 10000, 20000, 30000, and 40000 (rpm), the purge flow rate PQ is higher among 0, 0.4, 0.7, 1.0, and 1.5 (g/sec).

In step 210, the ECU 50 calculates a request injector decrement RIDQ based on the following expression (2):

RIDQ=(SAF*PQ*PR)/(PAF*Ga) (Exp. 2)

wherein “PR” represents a purge rate of vapor.

In the processings in steps 200 and 210, when the intake amount Ga of the engine 1 decreases, the ECU 50 calculates the request injector decrement RIDQ from the actual pump rotation number NP and the vapor concentration VPs (the purge air-fuel ratio PAF).

In step 220, successively, the ECU 50 determines whether or not a resultant value obtained by subtracting the guard decrement GDQ from the request injector decrement RIDQ is equal to or larger than 10%. This value “10%” is one example. If YES in step 220, the ECU 50 advances the processing to step 230. If NO in step 220, the ECU 50 shifts the processing to step 240.

In step 230, the ECU 50 closes the purge valve 24 to perform the purge cut and then temporarily stops the processing.

In step 240, in contrast, the ECU 50 permits the purge control to be performed. In other words, the ECU 50 continues to control the purge valve 24 to open and the purge pump 25 to rotate. Subsequently, the ECU 50 temporarily stops the processing.

In the processings in step 220 to step 240, when the request injector decrement RIDQ greatly deviates from the guard decrement GDQ (e.g., 40%), the ECU 50 closes the purge valve 24 to perform the purge cut. When this deviation becomes smaller, the ECU 50 permits the purge control to restart purging.

According to the foregoing purge cut control, when the actual intake amount Ga becomes smaller than the upper-limit intake amount GaMX, the ECU 50 controls the injector 8 to decrease the fuel to be supplied to the engine 1 in a range down to the predetermined limit value (i.e., the guard decrement GDQ) and, if the amount of decrease of the fuel to be decreased only by the injector 8 is not sufficient for the decreased intake amount, the ECU 50 closes the purge valve 24 to cut off purging of vapor, i.e., to perform the purge cut.

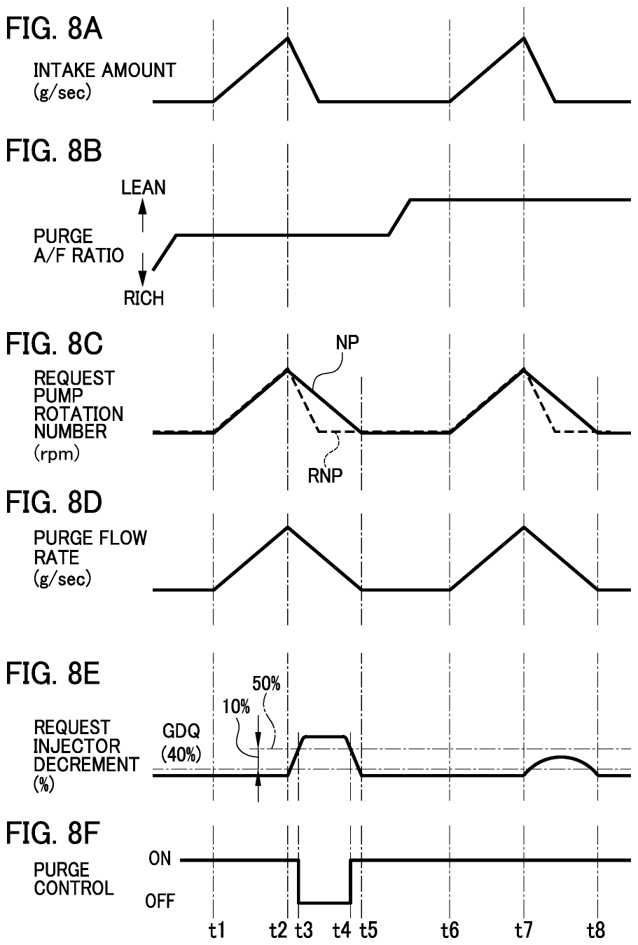

Herein, one example of behaviors of various parameters in the foregoing purge cut control is shown in time charts in FIGS. 8A-8F. FIG. 8A shows variations in intake amount Ga, FIG. 8B indicates variations in purge air-fuel ratio PAF, FIG. 8C exhibits variations in request pump rotation number RNP (and pump rotation number NP), FIG. 8D shows variations in purge flow rate PQ, FIG. 8E shows variations in request injector decrement RIDQ, and FIG. 8F shows changes in purge control.

In FIGS. 8A-8F, at time t1, when the purge air-fuel ratio in FIG. 8B is a certain value and the intake amount Ga 8 in FIG. 8A starts to increase, the request pump rotation number RNP and the pump rotation number NP in FIG. 8C start to increase, and the purge flow rate PQ in FIG. 8D starts to increase. Thereafter, at time t2, when the intake amount Ga in FIG. 8A reaches a peak and starts to decrease, the request pump rotation number RNP and the pump rotation number NP in FIG. 8C reach a peak and starts to decrease, the purge flow rate PQ in FIG. 8D reaches a peak and starts to decrease, and the request injector decrement RIDQ in FIG. 8E starts to increase.

At time t3, when a difference between the request injector decrement RIDQ (50%) in FIG. 8E and the guard decrement GDQ (40%) is equal to or larger than 10%, the purge control in FIG. 8F is turned from ON to OFF. At time t4, when the difference between the request injector decrement RIDQ in FIG. 8E and the guard decrement GDQ becomes smaller than 10%, the purge control in FIG. 8F is turned from OFF to ON. In other words, when the request injector decrement RIDQ is larger than the guard decrement GDQ by 10% or more, the purge valve 24 is closed to perform the purge cut.

Thereafter, the intake amount Ga in FIG. 8A becomes constant and the purge air-fuel ratio PAF in FIG. 8B changes to lean. At time t6, when the intake amount Ga in FIG. 8A starts to increase, the request pump rotation number RNP and the pump rotation number NP in FIG. 8C start to increase and the purge flow rate PQ in FIG. 8D starts to increase. At time t7, when the intake amount Ga in FIG. 8A reaches a peak and starts to decrease, the request pump rotation number RNP and the pump rotation number NP in FIG. 8C reach a peak and start to decrease, the purge flow rate PQ in FIG. 8D reaches a peak and starts to decrease, and the request injector decrement RIDQ in FIG. 8E starts to increase.

Between time t7 to time t8, subsequently, a difference between the request injector decrement RIDQ in FIG. 8E and the guard decrement GDQ is smaller than 10%. Thus, the purge control in FIG. 8F is not turned from ON to OFF. In other words, unless the request injector decrement RIDQ becomes larger than the guard decrement GDQ by 10% or more, the purge valve 24 remains opened and thus the purge cut is not carried out.

The engine system in the second embodiment described above can achieve the operations and advantages similar or equivalent to those in the first embodiment.

### Third Embodiment

Next, a third embodiment embodying an engine system will be described in detail below with reference to the accompanying drawings. The third embodiment differs from the first embodiment in the contents of the purge control.

### (Second Purge Control)

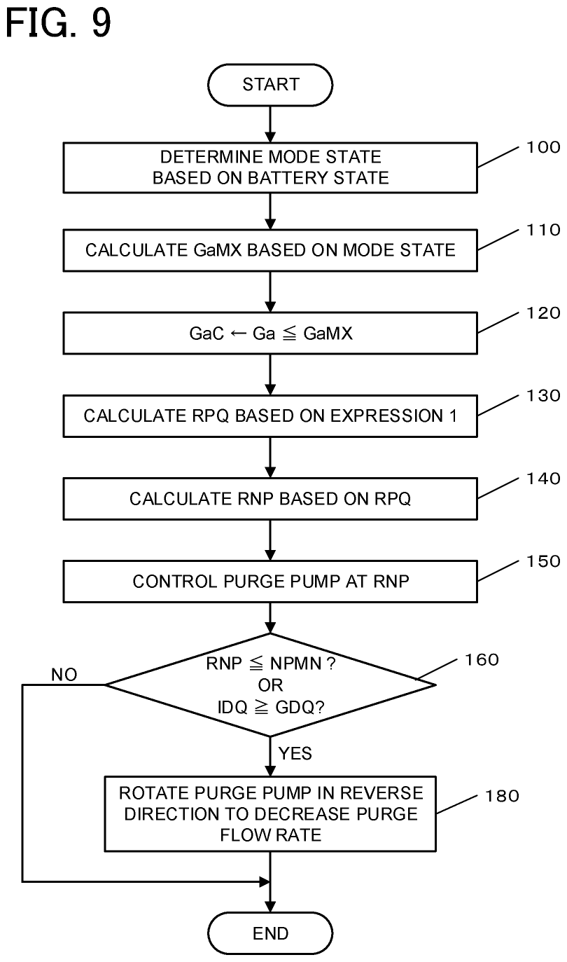

The second purge control will be described below. FIG. 9 is a flowchart showing details of this second purge control. The second purge control is configured to perform the processing in step 180 in FIG. 9 instead of the processing in step 170 in FIG. 2.

When the processing enters this routine, the ECU 50 performs the processings in steps 100 to 160, which are the same as in FIG. 2. If YES in step 160, the ECU 50 advances the processing to step 180.

In step 180, the ECU 50 reversely rotates the purge pump 25 to decrease the purge flow rate and temporarily stops the subsequent processing. This reverse rotation of the purge pump 25 causes the vapor to flow toward the intake passage 3 without flowing back through the purge passage 23 by the property of a turbine pump. In addition, the reverse rotation of the purge pump 25 allows the vapor to flow at a lower flow rate than when the purge pump 25 normally rotates at the same number of rotations.

According to the foregoing second purge control, differently from the first embodiment, when the actual intake amount Ga becomes smaller than the upper-limit intake amount GaMX and the request pump rotation number RNP becomes equal to or lower than the lower-limit pump rotation number NPMN, or alternatively, when the injector decrement IDQ becomes equal to or larger than the guard decrement GDQ, the ECU 50 is configured to reversely rotate the purge pump 25 to decrease the purge flow rate of vapor.

According to the second purge control described above, differently from the first embodiment, when the actual intake amount Ga becomes smaller than the upper-limit intake amount GaMX, the ECU 50 is configured to control the injector 8 to decrease the fuel to be supplied to the engine 1 in a range down to the predetermined limit value (the guard decrement GDQ) and, if the amount of decrease of the fuel to be decreased only by the injector 8 is not sufficient for the decreased intake amount, the ECU 50 reversely rotates the purge pump 25.

The engine system in the present embodiment described above can achieve the following operations and advantages different from those of the processing in step 170 in FIG. 2 in the first embodiment. In the present embodiment, specifically, when the actual intake amount Ga becomes smaller than the upper-limit intake amount GaMX and the request pump rotation number RNP becomes equal to or lower than the lower-limit pump rotation number NPMN, or alternatively, when the actual intake amount Ga becomes smaller than the upper-limit intake amount GaMX and the injector decrement IDQ becomes equal to or larger than the guard decrement GDQ, the purge pump 25 is reversely rotated, causing the purge flow rate of vapor to promptly and accurately decrease. Accordingly, the engine system in the present embodiment can promptly and accurately decrease the amount of vapor to be supplied to the engine 1 by the purge pump 25 and quickly and precisely reduce air-fuel ratio disturbance in the engine 1.

According to the present embodiment, when the actual intake amount Ga becomes smaller than the upper-limit intake amount GaMX, the injector 8 is controlled so as to decrease the fuel to be supplied to the engine 1 in a range down to the predetermined guard decrement GDQ. Further, if the amount of decrease of the fuel to be decreased only by the injector 8 is not sufficient for the decreased intake amount, the purge pump 25 of a turbine type is caused to reversely rotate, thereby promptly and accurately decreasing the amount of vapor to be supplied to the engine 1. Accordingly, when the actual intake amount Ga falls below the upper-limit intake amount GaMX, even if only the amount of decrease of the fuel to be decreased only by the injector 8 is insufficient, the engine system in the present embodiment can promptly and accurately suppress excessive supply of vapor to the engine 1 by the purge pump 25, and thus can restrict an air-fuel ratio disturbance in the engine 1.

### Fourth Embodiment

Next, a fourth embodiment embodying an engine system will be described in detail below with reference to the accompanying drawings.

In the fourth embodiment, similar or identical parts to those in the third embodiment are given the same reference signs as those in the third embodiment and their details are not elaborated upon here. The following description is made with a focus on differences from the third embodiment. The present embodiment differs from the third embodiment in the contents of the purge control.

In the vaporized-fuel treating apparatus 30 in the present embodiment, the purge valve 24 constituted of a shutoff valve and the turbine purge pump 25 are provided in the purge passage 23. Accordingly, the purge valve 24 cannot control the purge flow rate PQ. This purge flow rate PQ can be controlled by control of the number of rotations of the purge pump 25. When the intake amount Ga in the engine 1 is small, the purge flow rate PQ according to the intake amount Ga could not be ensured unless the purge pump 25 is operated. This may deteriorate the controllability of an air-fuel ratio in the engine 1. On the other hand, when the vapor concentration VPs is rich, the controllability of an air-fuel ratio in the engine 1 may deteriorate unless purging is controlled at a low flow rate. If the purge pump 25 is a low-priced one, generally, its minimum pump rotation number is relatively high (e.g., 10000 (rpm)), which causes the difficulty in controlling purging at a low flow rate. In contrast, the purge pump 25 configured as a turbine pump in the present embodiment has only to be reversely rotated to enable purging at a low flow rate even at a relatively high pump rotation number. In the present embodiment, therefore, the second purge control in FIG. 9 is configured to perform the following purge pump control instead of the processing in the step 180.

### (Purge Pump Control)

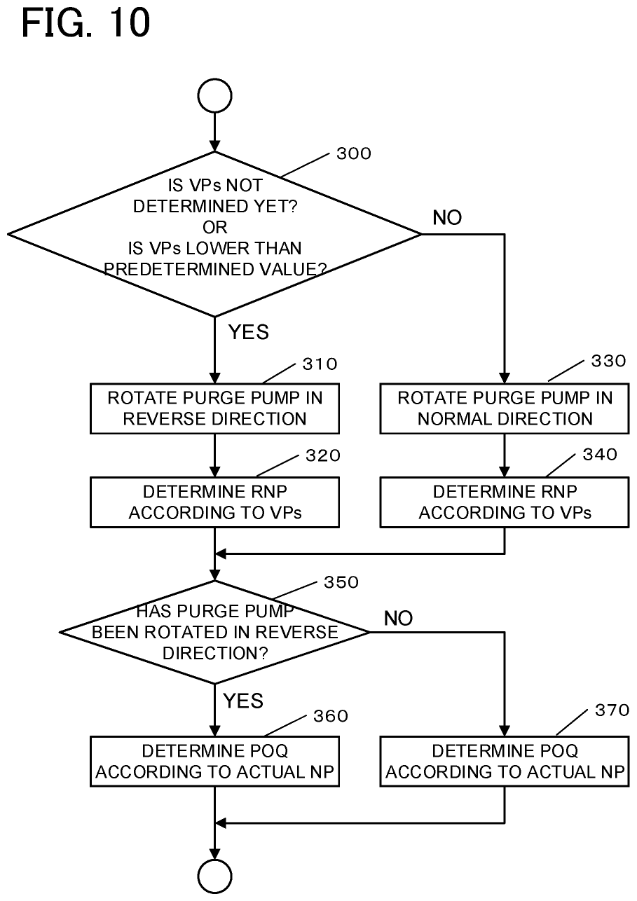

The purge pump control will be described below. FIG. 10 is a flowchart showing the contents of the purge pump control to be performed instead of step 180 in FIG. 9.

When the processing shifts from step 160 in FIG. 9 to step 300 in FIG. 10, the ECU 500 determines, in step 300, either (i) whether or not the vapor concentration VPs is not determined yet or (ii) whether or not the vapor concentration VPs is lower than a predetermined value. Herein, the ECU 50 can obtain the vapor concentration VPs based on a detection value of the vapor concentration sensor 47. If YES in step 300, the ECU 50 advances the processing to step 310. If NO in step 300, the ECU 50 shifts the processing to step 330.

In step 310, the ECU 50 reversely rotates the purge pump 25 to perform purging at a low flow rate. In other words, if the vapor concentration VPs is rich, the purge pump 25 is reversely rotated to ensure purging at a low flow rate.

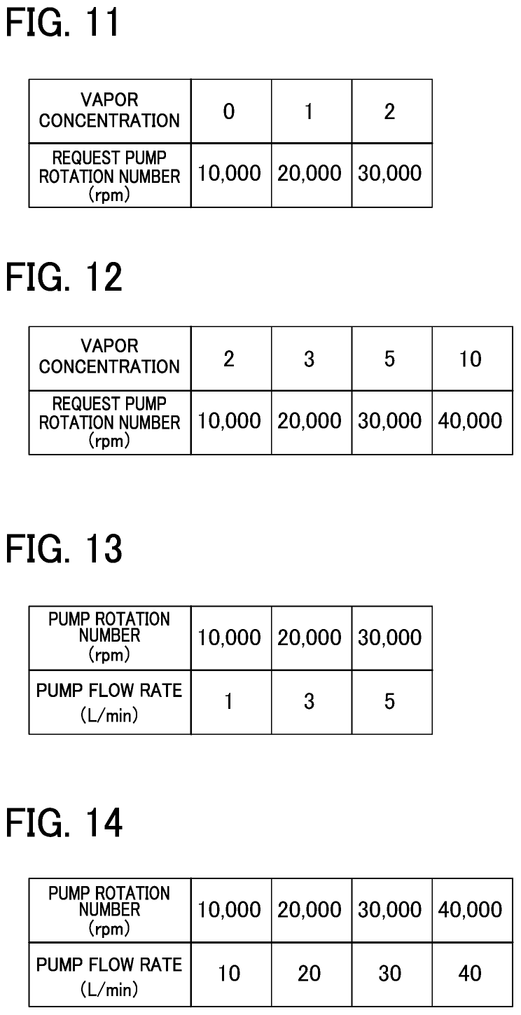

In step 320, the ECU 50 then determines the request pump rotation number RNP according to the vapor concentration VPs. For instance, the ECU 50 can obtain the request pump rotation number RNP according to the vapor concentration VPs by referring to a first request pump rotation number map set in advance as shown in FIG. 11. In this map, as the vapor concentration VPs is higher among 0, 1, and 2, the request pump rotation number RNP is higher among 10000, 20000, and 30000 (rpm).

In step 330, on the other hand, the ECU 50 normally rotates the purge pump 25 to ensure a necessary purge flow rate PQ.

In step 340, the ECU 50 determines the request pump rotation number RNP according to the vapor concentration VPs. For instance, the ECU 50 can obtain the request pump rotation number RNP according to the vapor concentration VPs by referring to a second request pump rotation number map set in advance as shown in FIG. 12. In this map, as the vapor concentration VPs is higher among 2, 3, 5, and 10, the request pump rotation number RNP is higher among 10000, 20000, 30000, and 40000 (rpm).

In step 350 following either step 320 or step 340, the ECU 50 determines whether or not the purge pump 25 has been reversely rotated. If YES in step 350, the ECU 50 advances the processing to step 360. If NO in step 350, the ECU 50 shifts the processing to step 370.

In step 360, the ECU 50 determines a pump flow rate POQ according to the actual pump rotation number NP. For example, the ECU 50 can obtain the pump flow rate POQ according to the actual pump rotation number NP by referring to a first pump flow rate map set in advance as shown in FIG. 13. In this map, as the pump rotation number NP is higher among 10000, 20000, and 30000 (rpm), the pump flow rate POQ is larger among 1, 3, and 5 (L/min). Thereafter, the ECU 50 temporarily stops the processing.

In step 370, in contrast, the ECU 50 determines the pump flow rate POQ according to the actual pump rotation number NP. For instance, the ECU 50 can obtain this pump flow rate POQ according to the actual pump rotation number NP by referring to a second pump flow rate map set in advance as shown in FIG. 14. In this map, as the pump rotation number NP is higher among 10000, 20000, 30000, and 40000 (rpm), correspondingly, the pump flow rate POQ is higher among 10, 20, 30, and 40 (L/min). The ECU 50 then temporarily stops the processing.

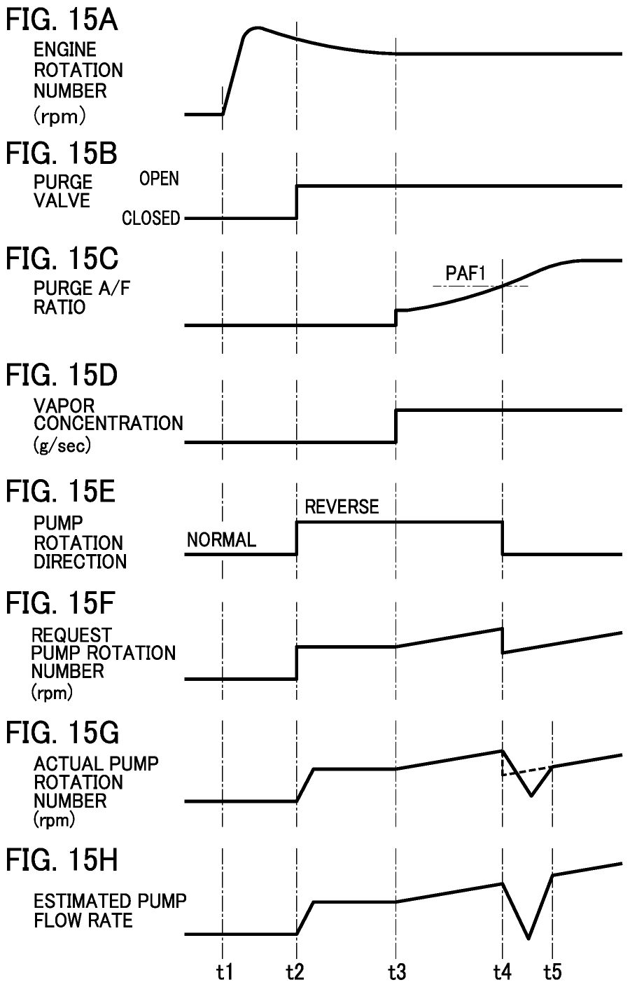

Herein, one example of behaviors of various parameters in the foregoing purge pump control is shown in time charts in FIG. 15A-15H. FIG. 15A shows variations in engine rotation number NE, FIG. 15B indicates an open/closed state of the purge valve 24, FIG. 15C exhibits variations in purge air-fuel ratio PAF, FIG. 15D shows variations in vapor concentration VPs, FIG. 15E shows changes in pump rotation direction, FIG. 15F shows variations in request pump rotation number RNP, FIG. 15G shows actual pump rotation number NP, and FIG. 15H shows variations in estimated pump flow rate.

In FIGS. 15A-15H, while the purge valve 24 in FIG. 15B is closed and the pump rotation direction in FIG. 15E indicates normal rotation, when the engine rotation number NE in FIG. 15A starts to increase sharply at time t1 and then decreases. Subsequently, at time t2, the purge valve 24 in FIG. 15B is opened, the pump rotation direction in FIG. 15E changes to reverse rotation, the request pump rotation number RNP in FIG. 15F is determined as a predetermined value, the actual pump rotation number NP in FIG. 15G starts to increase, and the estimated pump flow rate in FIG. 15H starts to increase.

Thereafter, while the purge valve 24 in FIG. 15B is opened and the purge pump 25 is under reverse rotation, when the purge air-fuel ratio PAF in FIG. 15C rises and the vapor concentration VPs increases at time t3, the request pump rotation number RNP in FIG. 15F, the actual pump rotation number NP in FIG. 15G, and the estimated pump flow rate in FIG. 15H start to slowly increase.

At time t4, when the purge air-fuel ratio PAF in FIG. 15C reaches a predetermined value PAF1, the pump rotation direction in FIG. 15E changes from “reverse rotation” to “normal rotation”. When the request pump rotation number RNP in FIG. 15F drops down, the actual pump rotation number NP in FIG. 15G and the estimated pump flow rate in FIG. 15H each decrease once between time t4 and time t5.

In the present embodiment, accordingly, when the purge pump 25 is rotated in a reverse rotation direction, as shown in a period between time t3 and time t4 in FIGS. 15A-15H, in association with slow (slight) change in the request pump rotation number RNP in FIG. 15F, the actual pump rotation number NP in FIG. 15G can be changed slowly (slightly) and the estimated pump flow rate can be changed slowly (at a low flow rate).

The engine system in the present embodiment described above can achieve the following operations and advantages in addition to the operations and advantages in the third embodiment. In the present embodiment, specifically, when the vapor concentration VPs becomes rich, the purge pump 25 is caused to reversely rotate to adjust the purging at a low flow rate. This can enhance the controllability of purging at a low flow rate and hence improve the controllability of the air-fuel ratio in the engine 1.

The foregoing embodiments are mere examples and give no limitation to the present disclosure. The present disclosure may be embodied in other specific forms without departing from the essential characteristics thereof.

(1) In each of the foregoing embodiments, the vapor concentration sensor 47 configured to directly detect the vapor concentration VPs is provided as a vaporized-fuel concentration detecting unit. As an alternative, an intake pressure sensor, an airflow meter, and an ECU may be provided as the vaporized-fuel concentration detecting unit to indirectly detect a vapor concentration. In this case, the ECU is configured to calculate an intake amount difference between an intake amount detected by the airflow meter while vapor is not purged into the intake passage and an intake amount detected by the airflow meter while vapor is being purged into the intake passage, and calculate an estimated purge flow rate of the vapor based on the opening degree of the purge valve in an open state and the intake pressure detected at that time by the intake pressure sensor. Furthermore, the ECU calculates a vapor density difference based on those intake amount difference and estimated purge flow rate and further calculates the vapor concentration based on the density difference.

(2) In each of the foregoing embodiments, the purge valve 24 is constituted of an on-off valve capable of operating between only two positions, that is, an open position (a fully-open position) and a closed position (a fully-closed position). As an alternative, the purge valve may be constituted of an electrically-operated valve capable of changing its opening degree.

(3) In each of the foregoing embodiments, the present disclosure is applied to the engine system equipped with no supercharger. As an alternative, the present disclosure may be applied to an engine system provided with a supercharger. In this case, an exit of the purge passage can be connected to the intake passage upstream of a compressor of the supercharger.

### INDUSTRIAL APPLICABILITY

The present disclosure is applicable to an engine system to be mounted in a hybrid vehicle.

### REFERENCE SIGNS LIST

1 Engine
3 Intake passage
5 Fuel tank
8 Injector (Fuel supply unit)
21 Canister
23 Purge passage
24 Purge valve
25 Purge pump
30 Vaporized-fuel treating apparatus
41 Airflow meter (Intake amount detecting unit)
47 Vapor concentration sensor (Vaporized-fuel concentration detecting unit)
50 ECU (Controller)
60 Hybrid vehicle

What is claimed is:

1. An engine system to be mounted in a series-hybrid vehicle, the engine system comprising:
an engine;
an intake passage configured to introduce intake air into the engine;
a fuel supply unit configured to supply fuel to the engine;
a fuel tank configured to store the fuel to be supplied to the engine;
a vaporized-fuel treating apparatus including:
a canister configured to collect vaporized fuel generated in the fuel tank;
a purge passage;
a purge valve provided in the purge passage; and
a turbine purge pump provided in the purge passage,
the vaporized-fuel treating apparatus being configured to treat the vaporized fuel temporarily collected in the canister by purging the vaporized fuel into the intake passage through the purge passage;
a vaporized-fuel concentration detecting unit configured to detect a concentration of the vaporized fuel to be purged into the intake passage;
an intake amount detecting unit configured to detect an intake amount of air flowing through the intake passage; and
a controller configured to control the fuel supply unit, the purge valve, and the purge pump,
the controller being configured to:
control the fuel supply unit to regulate an amount of the fuel to be supplied to the engine during operation of the engine;
open the purge valve to regulate an amount of the vaporized fuel to be purged into the intake passage;
calculate a request pump rotation number based on the detected intake amount and the detected concentration of the vaporized fuel; and
control the purge pump based on the calculated request pump rotation number,
wherein when the intake amount increases above a predetermined upper-limit intake amount during steady operation of the engine, the controller is configured to limit an upper limit of the detected intake amount to the predetermined upper-limit intake amount, and calculate the request pump rotation number based on the upper-limit intake amount and the concentration of the vaporized fuel.

2. The engine system according to claim 1, wherein
when the intake amount decreases below the predetermined upper-limit intake amount, the controller is configured to control the fuel supply unit to decrease the amount of the fuel to be supplied to the engine, and control at least one of the purge valve and the purge pump to decrease the amount of the vaporized fuel to be supplied to the engine as needed.

3. The engine system according to claim 2, wherein
when the intake amount decreases below the predetermined upper-limit intake amount,
the controller is configured to control the fuel supply unit to decrease the amount of the fuel to be supplied to the engine in a range down to a predetermined limit value, and
when an amount of decrease of the fuel to be decreased only by the fuel supply unit is insufficient for the decreased intake amount, the controller is configured to close the purge valve to shut off purging of the vaporized fuel.

4. The engine system according to claim 2, wherein
when the intake amount decreases below the predetermined upper-limit intake amount,
the controller is configured to control the fuel supply unit to decrease the amount of the fuel to be supplied to the engine in a range down to a predetermined limit value, and
when an amount of decrease of the fuel to be decreased only by the fuel supply unit is insufficient for the decreased intake amount, the controller is configured to rotate the purge pump in a reverse direction.
